(19) United States
(12) Patent Application Publication
(10) Pub. No.: US 2021/0251192 A1
(43) Pub. Date: Aug. 19, 2021

(54) HAMSTER RUNNING WHEEL AND AXIAL CONNECTION DEVICE FOR HAMSTER RUNNING WHEEL

(71) Applicant: SHENZHEN ZHI NAN REN TECHNOLOGY CO., LTD., SHENZHEN CITY, GUANGDONG PROVINCE (CN)

(72) Inventor: ZHIYANG HU, SHENZHEN CITY, GUANGDONG PROVINCE (CN)

(21) Appl. No.: 16/982,100

(22) PCT Filed: Aug. 18, 2020
(86) PCT No.: PCT/CN2020/109795

§ 371 Date: Sep. 18, 2020

(30) Foreign Application Priority Data
Aug. 20, 2019 (CN) 201910769859.1
Jan. 15, 2020 (CN) 202020087269.9
Jan. 15, 2020 (CN) 202020092625.6

(51) Int. Cl. A01K 15/02; F16M 11/04

(52) U.S. Cl. CPC A01K 15/027; F16M 2200/025; F16M 11/046

(57) ABSTRACT

A hamster running wheel and an axial connection device for a hamster running wheel are provided. The hamster running wheel includes a support frame (2) and a running wheel body (1) supported on the support frame (2) through a rotating mechanism (3). The rotating mechanism (3) includes an axial mechanism (32) and a plurality of bearings (33). The plurality of the bearings (33) are stacked to form a bearing set, and are arranged in series on the axial mechanism (32). The inner rings of the plurality of the bearings are fixedly connected to the axial mechanism (32), and the outer rings of the plurality of the bearings are fixedly connected to the running wheel body.

### CROSS-REFERENCE TO RELATED PATENT APPLICATION

This application claims the benefit of priority to China Patent Application No. 201910769859.1, 202020087269.9 and 202020092625.6. The entire content of the above identified application is incorporated herein by reference.

### FIELD OF THE DISCLOSURE

The present disclosure relates to pet supplies, in particular, to a hamster running wheel for hamster exercise, and an axial connection device for a hamster running wheel.

### BACKGROUND OF THE DISCLOSURE

Hamsters are a kind of small pets that people prefer. They have sports-loving characteristics. Wild hamsters need to run 5 kilometers a day. Hamster breeding needs to provide exercise mechanisms for them to run. The running wheel occupies a small space and can meet the sports needs of hamsters. The existing hamster running wheel for hamster exercise is composed of a support frame and a running wheel body. The running wheel body is supported on the support frame through a rotating mechanism, wherein the rotating mechanism is composed of a shaft and a bearing, and the shaft is fixed to the support frame. The bearing is sleeved on the shaft, the inner ring of the bearing is fixed with the shaft, the outer ring of the bearing is fixed with a wooden connecting plate, and the center of the running wheel body is fixed on the wooden connecting plate by a nail.

The hamster running wheel has the following defects. 1. When in use, the vibration and the noise are large, and the rotation speed is too fast. 2. After using for a period of time, the running wheel body needs to be removed for cleaning, but the above structure is inconvenient to disassemble, and it is difficult to find the center of the running wheel body when reinstalling, so it is not easy to align the center of the running wheel body with the axis of the rotating mechanism accurately, resulting in difficult installation and positioning. 3. After long time use, the running wheel body may fall off. 4. The distance between the running wheel body and the bracket is small, and the locking operation of the shaft of the rotating mechanism and the support frame is difficult. 5. The height cannot be adjusted.

In addition, some hamster running wheels still have the following defects. As the use time increases, the stability becomes worse and the noise increases.

Further, the existing hamster running wheels have the following problems. 1. The running track and the end cover are snap-fitted, and there will inevitably be gaps, protrusions, burrs, etc. at the matching place. Since the running wheel rotates very fast when the hamster moves, these gaps, protrusions, burrs, etc. are likely to cause injury to the hamster's toes, tail, etc., that is, poor safety. 2. In order to prevent the hamster from slipping when it is moving, its runway is composed of an inner layer of cork with strong adhesion and a reinforcing outer layer nested outside the inner layer of cork. With this kind of running wheel, the hamster's feces will be immersed into the inner layer of cork, making it difficult to remove.

### SUMMARY OF THE DISCLOSURE

The first object of the present disclosure is to provide a hamster running wheel to solve the defects of large vibration, high noise and excessively fast rotation speed of the existing hamster running wheel.

The second object of the present disclosure is to provide a hamster running wheel to solve the defect of difficult installation and positioning in the existing hamster running wheel.

The third object of the present disclosure is to provide a hamster running wheel to solve the defect that the existing hamster running wheel has the risk of falling off.

The fourth object of the present disclosure is to provide a hamster running wheel to solve the defect that it is difficult to lock the shaft of the rotating mechanism and the support frame of the existing hamster running wheel.

The fifth object of the present disclosure is to provide a hamster running wheel to solve the defect that the existing hamster running wheel cannot be adjusted in height.

The sixth object of the present disclosure is to provide an axial connection device for a hamster running wheel to reduce abrasion and prolong the service life.

The seventh object of the present disclosure is to provide a safe hamster running wheel that is convenient to be cleaned.

In order to achieve the above-mentioned first object of the present disclosure, a hamster running wheel is provided, comprising: a support frame and a running wheel body supported on the support frame through a rotating mechanism, wherein the rotating mechanism comprises an axial mechanism and a plurality of bearings, wherein the plurality of the bearings are stacked to form a bearing set, and are arranged in series on the axial mechanism, wherein inner rings of the plurality of the bearings are fixedly connected to the axial mechanism, and outer rings of the plurality of the bearings are fixedly connected to the running wheel body.

Compared with a rotating mechanism having only one bearing, the present application adopts multiple bearings to form a bearing set, which greatly increases the contact area between the fixed part and the moving part of the rotating mechanism. The support between the fixed part and the moving part is more stable, which reduces the shaking (vibration) noise during exercise, and on the other hand, it increases the friction between the moving part and the fixed part, so that under the same external force, the rotation speed of the running wheel can be reduced.

In order to achieve the above-mentioned second objective, the present disclosure further increases an alignment calibration mechanism based on the above-mentioned hamster running wheel, wherein the alignment calibration mechanism comprises: a positioning hole opened in a center of the running wheel body; and a positioning member sleeved on the rotating mechanism and fixedly connected to the outer rings of the plurality of the bearings of the rotating mechanism, wherein a first positioning portion is embedded in the positioning hole and cooperates with the positioning hole to radially position the running wheel body, and a second positioning portion is located at one end of the first positioning portion, and abuts against and cooperates with an end of the running wheel body to axially position the running wheel body.

When in use, only the positioning hole of the running wheel body needs to be sleeved on the first positioning portion of the positioning member, and the end of the running wheel body is pressed against the second positioning portion to complete the positioning of the running wheel body. Not only the radial positioning of the running wheel body is embodied, but also the axial positioning of the running wheel body is embodied, and the positioning is convenient, fast and accurate.

Preferably, the first positioning portion and the second positioning portion are both cylindrical structures and axially coincident, which facilitates to the uniform movement of the running wheel body.

Preferably, a plurality of screw holes are provided at an end of the second positioning portion adjacent to the running wheel body, and a plurality of installation holes corresponding to the plurality of screw holes are provided on the running wheel body, wherein a plurality of screws correspondingly passing through the plurality of installation holes and connecting the plurality of screw holes lock the running wheel body to the positioning member. In this way, not only the running wheel body can be locked reliably, but also the disassembly and installation are convenient.

In order to achieve the above-mentioned third objective, the hamster running wheel of the present disclosure further comprises an anti-falling mechanism for running wheel, and the anti-falling mechanism for running wheel comprises: a fixed end cover and a limiting member, wherein the limiting member is fixedly mounted at a near running wheel end of the axial mechanism, the fixed end cover is assembled on the near running wheel end of the axial mechanism, and the fixed end cover is limited by the limiting member so as to have a gap with the running wheel body.

The above-mentioned limiting member makes a gap between the fixed end cover and the running wheel body, so that the fixed end cover will not follow the running wheel body to rotate. Therefore, no matter whether the running wheel body rotates clockwise or counterclockwise, the fixed end cover will not loosen, thereby protecting the running wheel body from falling off

Preferably, a threaded structure is provided on the near running wheel end of the axial mechanism and the fixed end cover is connected to the axial mechanism via the threaded structure. The threaded structure connection makes it easier to disassemble and install.

Preferably, the fixed end cover has a circular structure, which facilitates to the uniform movement of the running wheel body.

Preferably, the limiting member is a sleeve, and the sleeve is punched and sleeved on the near running wheel end of the axial mechanism.

In order to achieve the above-mentioned fourth objective, the hamster running wheel further comprises: an auxiliary assembly mechanism, wherein the auxiliary assembly mechanism comprises: a clamping position arranged on the axial mechanism for tool clamping, and a diameter of the clamping position of the axial mechanism is larger than a diameter of a proximal bracket end of the axial mechanism.

By means of the clamping position, the axial mechanism can be conveniently clamped with pliers, making the disassembly and assembly operations of the rotating mechanism and the support frame easy.

Preferably, the clamping position is a regular hexagonal prism.

In order to achieve the above-mentioned fifth objective, the hamster running wheel further comprises: a height adjustment mechanism, wherein the height adjustment mechanism comprises: a wing nut and a strip through hole provided on a support portion of the support frame, wherein a proximal bracket end of the axial mechanism passes through the strip through hole, the wing nut is connected with the proximal bracket end of the axial mechanism to lock the axial mechanism on the support portion.

The rotating mechanism and the support frame can be easily loosened/locked through the wing nut, the strip through hole is matched with the axial mechanism, and the rotating mechanism can be easily raised and lowered, thereby conveniently adjusting the height of the running wheel body.

In order to achieve the above-mentioned sixth objective, through research and analysis, the inventor found that the reason for the above-mentioned defects in the related technology is that the position of the bearing deviates from the center of gravity of the running wheel body. Based on this research, the following solutions are proposed. An axial connection device for a hamster running wheel for rotatably supporting a running wheel body on a support frame is provided, wherein the axial connection device for a hamster running wheel comprises: a shaft; bearings mounted on the shaft; and a positioning member mounted on the bearing for carrying the running wheel body; wherein the positioning member comprises: a first positioning portion configured to cooperate with a center hole of a back plate of the running wheel body to support the running wheel body and embody radial positioning, and a second positioning portion located at one end of the first positioning portion and configured to abut against the back plate of the running wheel body to embody axial positioning, wherein the bearings are embedded at a side adjacent to the positioning member in the first positioning portion.

Preferably, the first positioning portion and the second positioning portion are both circular truncated cone-shaped and axially coincident.

Preferably, one end of the second positioning portion adjacent to the running wheel body is further provided with a plurality of locking holes for locking the running wheel body.

Preferably, a plurality of bearings are mounted on the shaft, and the plurality of bearings are arranged side by side.

In the axial connection device for a hamster running wheel, preferably, a gap of 0.5-1.5 mm is between the adjacent bearings.

In the axial connection device for a hamster running wheel, preferably, the bearings are rolling bearings.

In the axial connection device for a hamster running wheel, preferably, the shaft is further provided with a clamping position that is exposed between the support frame and the back plate of the running wheel body for tool clamping.

In order to achieve the above-mentioned seventh objective, a safe hamster running wheel convenient to be cleaned is provided, comprising: a support frame; and a rotatable running wheel body mounted on the support frame via an axial connection device, wherein the running wheel body comprises an annular plastic track, and a plastic end cover ultrasonically welded at an opening of the annular plastic track, wherein an anti-slip portion is provided on a surface of the annular plastic track.

In the safe hamster running wheel convenient to be cleaned, preferably, the anti-slip portion is a convex bar or a groove with an arc-shaped cross section.

In the safe hamster running wheel convenient to be cleaned, preferably, the convex bar or the groove is parallel to the axial connection device.

In the safe hamster running wheel convenient to be cleaned, preferably, the axial connection device comprises: a shaft; a bearing mounted on the shaft; and a positioning member mounted on the bearing for carrying the running wheel body; wherein the positioning member comprises: a first positioning portion for cooperating with a center hole of an end cover of the running wheel body to support the running wheel body and embody radial positioning, and a second positioning portion located at one end of the first positioning portion for abutting against the end cover of the running wheel body to embody axial positioning, wherein the bearing is embedded at a side adjacent to the first positioning portion in the positioning member.

In the safe hamster running wheel convenient to be cleaned, preferably, a plurality of bearings are provided on the shaft, the plurality of bearings are arranged side by side, and a gap of 0.5-1.5 mm is between the adjacent bearings.

In the safe hamster running wheel convenient to be cleaned, preferably, the axial connection device is locked to the support frame through a nut, and the height is adjustable.

Compared with the prior art, the present disclosure has at least the following beneficial effects.

The hamster running wheel provided to achieve the first to fifth objectives has the characteristics of low noise and low rotation speed, convenient disassembly and installation, high reliability; the running wheel body will not fall off; the height is adjustable, and it is convenient to use in different spaces.

The bearings of the axial connection device provided for achieving the sixth objective are closer to the center of gravity of the running wheel body, and when the running wheel is moving, the wear of the bearings and the shaft is effectively reduced, and the service life is prolonged.

### BRIEF DESCRIPTION OF THE DRAWINGS

FIG. 1 is a three-dimensional schematic diagram of the hamster running wheel of the first embodiment.

FIG. 2 is a schematic diagram of the back structure of the first embodiment.

FIG. 3 is a side view of the first embodiment.

FIG. 4 is a disassembled state diagram of the first embodiment.

FIG. 5 is a schematic diagram of the structure of the hamster running wheel of the first embodiment.

FIG. 6 is a schematic diagram of the structure of the positioning member of the first embodiment.

FIG. 7 is a state diagram after the positioning member and the rotating mechanism of the first embodiment are combined.

FIG. 8 is a schematic diagram of the structure of the axial connection device of the second embodiment.

FIG. 9 is an exploded view of the axial connection device of the second embodiment.

FIG. 10 is a schematic structural diagram of a hamster running wheel adopting the axial connection device of the second embodiment.

FIG. 11 is a schematic structural diagram of a safe hamster running wheel convenient to be cleaned of the third embodiment.

FIG. 12 is a schematic diagram of the structure of the running wheel body of the third embodiment.

FIG. 13 is an exploded view of the running wheel body of the third embodiment.

FIG. 14 is a schematic diagram of the structure of the axial connection device of the third embodiment

FIG. 15 is an exploded view of the axial connection device of the third embodiment.

FIG. 16 is a schematic diagram of the coupling part of the axial connection device, the running wheel body and the support frame of the third embodiment.

FIG. 17 is a schematic diagram of another example of the running wheel body of the third embodiment.

### DETAILED DESCRIPTION OF THE EXEMPLARY EMBODIMENTS

The present disclosure will be further described below in conjunction with the drawings and embodiments.

### The First Embodiment: Hamster Running Wheel

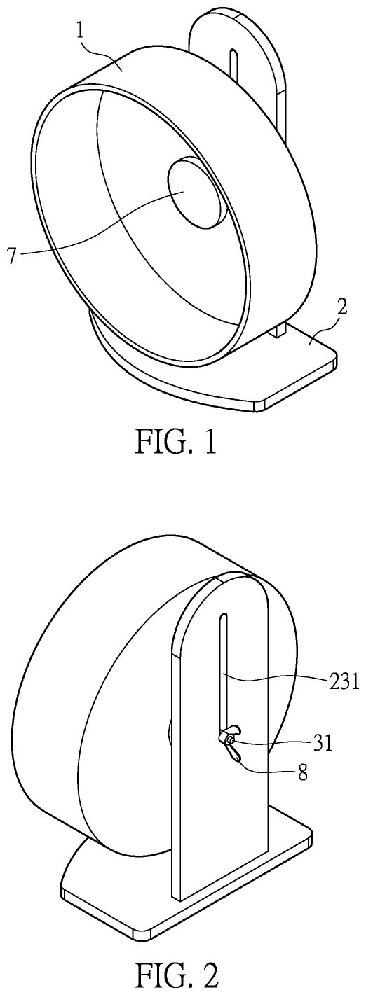

Referring to FIGS. 1 to 3, the hamster running wheel of this embodiment includes a support frame 2 and a running wheel body 1 supported on the support frame 2 through a rotating mechanism 3.

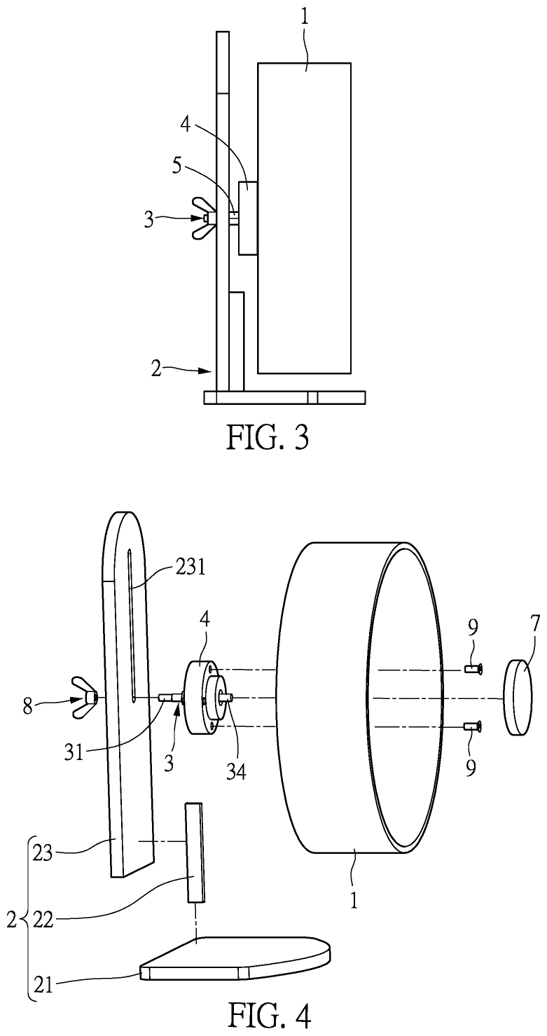

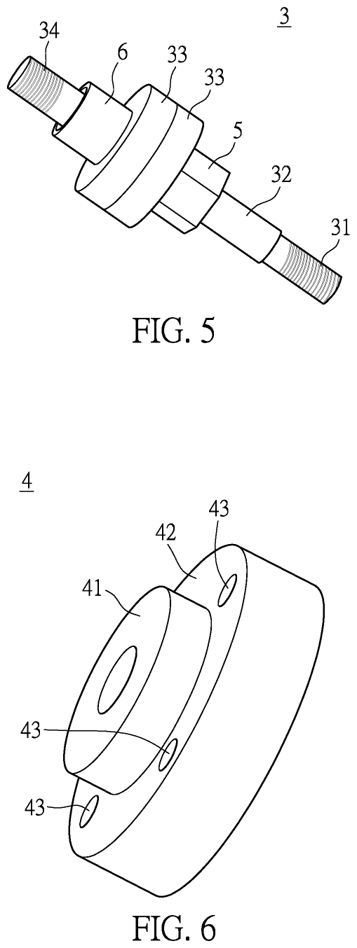

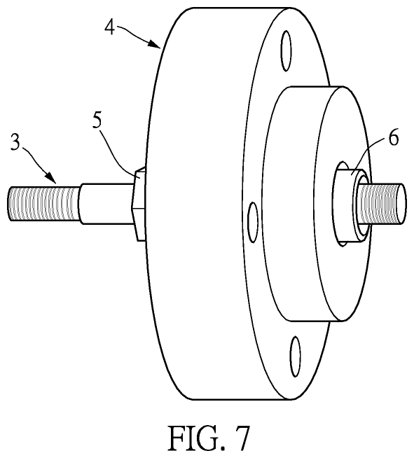

Referring to FIGS. 3, 4, 5, and 7, the rotating mechanism 3 includes an axial mechanism 32 and two bearings 33. The two bearings 33 are stacked to form a bearing set, and the two bearings 33 are mounted on the axial mechanism 32 in series. The inner rings of the two bearings 33 are fixedly connected to the axial mechanism 32, the outer rings of the two bearings 33 are embedded and fixed in the positioning member 4, and are fixedly connected to the running wheel body 1 through the positioning member 4.

Compared with the design of a single bearing used in the rotating mechanism 3 in the existing hamster running wheel, the rotating mechanism 3 of this embodiment uses two bearings 33, so that the area of the moving contact part of the rotating mechanism 3 is doubled. The manner improves the stability of the movement, reduces the shaking (vibration) noise during the movement of the running wheel, and on the other hand, it also increases the friction during the movement, so that the rotation speed of the running wheel can be reduced when the hamster is running.

In order to facilitate the removal of the running wheel body 1 for cleaning and quick installation after cleaning, the hamster running wheel of this embodiment is further provided with an alignment calibration mechanism.

Referring to FIGS. 1 3, 4, 6, and 7, the alignment calibration mechanism includes a positioning hole (not shown) opened in a center of the running wheel body 1; and a positioning member 4 sleeved on the rotating mechanism 3 and fixedly connected with the outer rings of the bearings 33 of the rotating mechanism 3. The positioning member 4 includes a first positioning portion 41 embedded in the positioning hole in the center of the running wheel body 1 and cooperating with the positioning hole for radially positioning the running wheel body 1, and a second positioning portion 42 located at one end of the first positioning portion 41, and abutting against and cooperating with an end of the running wheel body 1 for axially positioning the running wheel body 1 (see FIG. 3).

With the above alignment and calibration mechanism, when in use, it is only necessary to sleeve the running wheel body 1 on the first positioning portion 41 of the positioning member 4 through the positioning hole in the center of the running wheel body 1, and push it to make the end of the running wheel body 1 abut against the second positioning portion 42 to complete the positioning of the running wheel body 1. Not only the radial positioning of the running wheel body 1 is embodied, but also the axial positioning of the running wheel body 1 is embodied, and the positioning is convenient, fast, and accurate.

Referring to FIGS. 4 and 6, a plurality of screw holes 43 are provided at an end of the second positioning portion 42 adjacent to the running wheel body 1, and a plurality of installation holes (not shown) corresponding to the plurality of screw holes 43 are provided on the running wheel body 1, wherein a plurality of screws 9 correspondingly passing through the plurality of installation holes and connecting the plurality of screw holes 43 lock the running wheel body 1 in the positioning member 4. In this way, not only the running wheel body 1 can be locked reliably, but also the disassembly and installation are convenient.

Further, the first positioning portion 41 and the second positioning portion 42 both have cylindrical structures and are axially coincident, which facilitates to the uniform movement of the running wheel body 1.

In order to prevent the running wheel from falling off during long-term rotation, the hamster running wheel of this embodiment is further provided with an anti-falling mechanism for running wheel.

Referring to FIGS. 1, 5, and 7, the anti-falling mechanism for running wheel includes a fixed end cover 7 and a limiting member 6, wherein the limiting member 6 is fixedly mounted at a near running wheel end 34 of the axial mechanism 32, the fixed end cover 7 is assembled on the near running wheel end 34 of the axial mechanism 32, and the fixed end cover 7 is limited by the limiting member 6 so as to have a gap with the running wheel body 1. The limiting member 6 adopts a sleeve, and the sleeve is punched and sleeved on the near running wheel end 34 of the axial mechanism 32. The limiting member 6 may also be a nut screwed on the axial mechanism 32, or a positioning block welded on the axial mechanism 32, or the like. The near running wheel end 34 of the axial mechanism 32 is provided with a threaded structure. The fixed end cap 7 is connected to the axial mechanism 32 via the threaded structure. The threaded structure is adopted for connection, which makes the disassembly and installation more convenient. Obviously, the fixed end cover 7 can be assembled to the near running wheel end 34 of the axial mechanism 32 by using a clamping connection structure. Further, the fixed end cover 7 is designed as a circular structure to facilitate the uniform movement of the running wheel body 1.

The above-mentioned limiting member 6 allows a gap between the fixed end cover 7 and the running wheel body 1, so that the fixed end cover 7 does not touch the running wheel body 1 and will not follow the running wheel body 1 to rotate. Therefore, no matter the running wheel body 1 rotates clockwise or counterclockwise, the fixed end cover 7 will not loosen, thereby protecting the running wheel body 1 from falling off.

In order to facilitate assembly and disassembly, the hamster running wheel of this embodiment is further provided with an auxiliary assembly mechanism.

Referring to FIGS. 3, 5, and 7, this auxiliary assembly mechanism includes a clamping position 5 arranged on the axial mechanism 32 for tool clamping, and a diameter of the clamping position 5 of the axial mechanism 32 is larger than a diameter of a proximal bracket end 31 of the axial mechanism 32. In this way, when the rotating mechanism 3 is installed to the support frame 2 through the proximal bracket end 31 of the axial mechanism 32, there is a gap between the support portion 23 of the support frame 2 and the running wheel body 1, and tools such as wrenches and pliers can be used to stretch into the gap and then clamp the clamping position 5 to clamp and fix the axial mechanism 32, which facilitates the loosening and tightening of the wing nut 8.

The clamping position 5 is designed as a regular hexagonal prism, which can be operated from multiple angles and is more convenient to use.

In order to conveniently adjust the height of the running wheel body 1 and adapt to use in different spaces, the hamster running wheel of this embodiment is further provided with a height adjustment mechanism.

Referring to FIGS. 2 and 4, the height adjustment mechanism includes a wing nut 8 and a strip through hole 231 provided on a support portion 23 of the support frame 2, wherein a proximal bracket end 31 of the axial mechanism 32 passes through the strip through hole 231, the wing nut 8 is connected with the proximal bracket end 31 of the axial mechanism 32 to lock the axial mechanism 32 on the support portion 23. The rotating mechanism 3 and the support frame 2 can be easily loosened/locked through the wing nut 8, and the strip through hole 231 cooperates with the axial mechanism 32 to easily lift the rotating mechanism 3, thereby conveniently adjusting the running wheel body 1 height.

The support frame 2 is composed of a base 21, a support portion 23 perpendicular to the base 21, and a small reinforcing plate 22 provided on one side of the support portion 23. The base 21, the support portion 23, and the small reinforcing plate 22 are all wooden boards.

### Second Embodiment: Axial Connection Device for Hamster Running Wheel

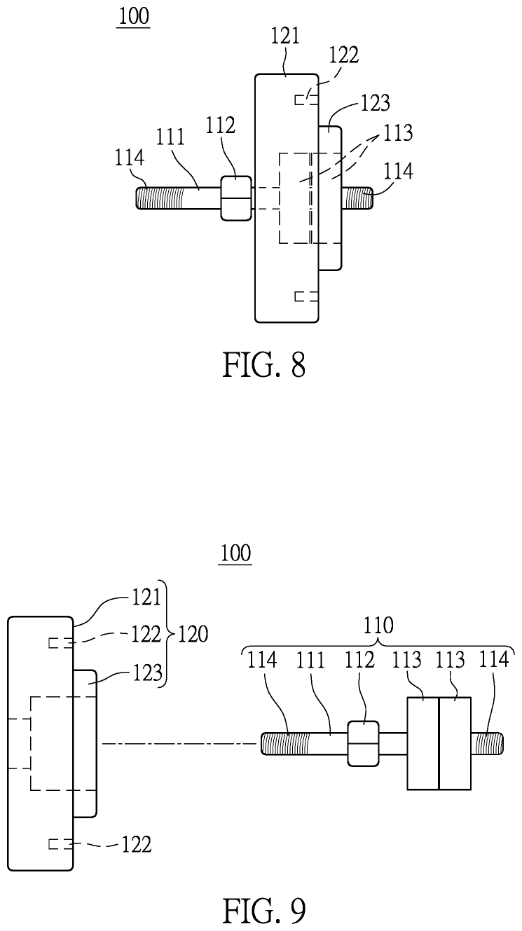

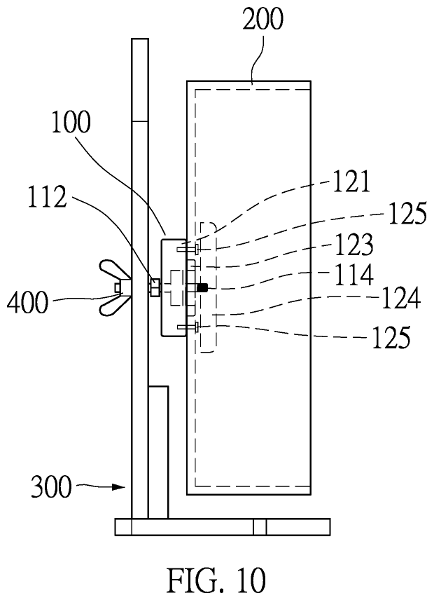

Referring to FIGS. 8 and 9, the axial connection device 100 for a hamster running wheel includes a shaft 111, two bearings 113, and a positioning member 120.

Two bearings 113 are fixedly mounted on the shaft 111, the two ends of the shaft 111 are respectively formed with connecting threads 114, and the middle of the shaft 111 is also formed with a clamping position 112. The above members are combined to form a rotating mechanism 110.

The positioning member 120 includes a first positioning portion 123 configured to cooperate with a center hole of a back plate of the running wheel body 200 to support the running wheel body 200 and embody radial positioning, and a second positioning portion 121 located at one end of the first positioning portion 123 and configured to abut against the back plate of the running wheel body 200 to embody axial positioning, wherein one end of the second positioning portion 121 adjacent to the running wheel body 200 is further provided with a plurality of locking holes 122 for locking the running wheel body 200.

The positioning member 120 is fixedly mounted on the two bearings 113 for carrying the running wheel body 200. More specifically, two bearings 113 are embedded at a side adjacent to the first positioning portion 123 in the positioning member 120 (the right side in FIG. 8).

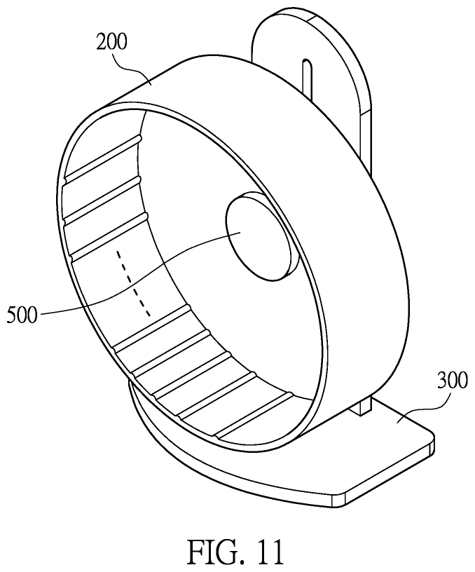

Referring to FIGS. 8 to 10, when in use, the first positioning portion 123 is inserted into the center hole of the back plate of the running wheel body 200, making the back plate of the running wheel body 200 abut against the second positioning portion 121, then the screw 125 is used to cooperate with the locking holes 122 on the second positioning portion 121 to lock the running wheel body 200 to the positioning member 120, and the shaft 111 is locked to the support frame 300 through the wing nut 400. Furthermore, a protective cover 124 is installed at the other end of the shaft 111. It can be seen that the bearings 113 in FIG. 8 is closer to the center of gravity of the running wheel body 200.

The above-mentioned bearings 113 are two rolling bearings, and a gap of 1 mm is between the two bearings 113. In this way, the contact surface between the bearings 113 and the shaft 111 is larger, and there is no friction between the bearings 113. Therefore, the movement is more reliable, and the shaking noise is smaller. The first positioning portion 123 and the second positioning portion 121 are both circular truncated cone-shaped and axially coincident, which is more convenient to the rotation of the running wheel. It should be understood that this is only a preferred embodiment, and the present disclosure is not limited thereto. A sliding bearing 113 can also be used, and the number of bearings can also be more or less.

The above-mentioned clamping position 112 is exposed between the support frame 300 and the back plate of the running wheel body 200 to facilitate the tool clamping for the shaft 111 during disassembly and assembly.

### The Third Embodiment: Safe Hamster Running Wheel Convenient to be Cleaned

Referring to FIGS. 11 to 16, the safe hamster running wheel convenient to be cleaned includes a support frame 300 and a running wheel body 200. The running wheel body 200 is mounted on the support frame 300 via an axial connection device 100, and can rotate around the axial connection device 100. When the hamster runs in the running wheel body 200, pushing the running wheel body 200 to rotate can satisfy the hamster's movement in a small space.

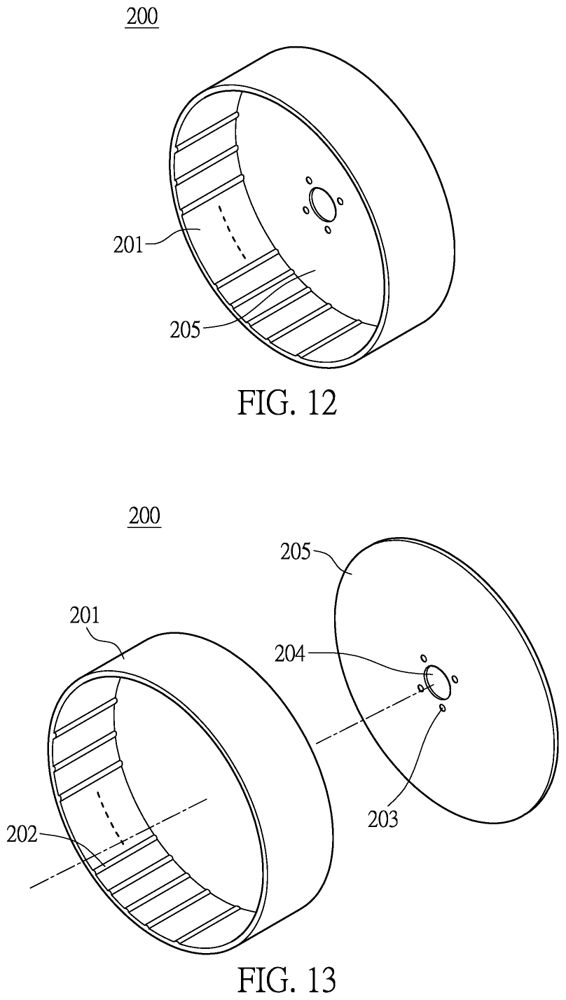

Referring to FIGS. 12 and 13, the running wheel body 200 includes an annular plastic track 201, and a plastic end cover 205 ultrasonically welded at an opening of the annular plastic track 201. Ultrasonic welding can weld the plastic members together. The joints after welding are smooth, without burrs, gaps, raised points, etc., so it can avoid injury to the hamster's toes and tail during exercise. In addition, because the feces will not be immersed in the plastic, the hamster running wheel also has the characteristics of convenient cleaning. Moreover, compared to a running wheel body composed of a cork inner layer and a reinforced outer layer, the running wheel body 200 of this embodiment is more convenient to manufacture.

An anti-slip portion 202 is provided on the surface of the plastic track. In this embodiment, the anti-slip portion 202 is specifically is a convex bar with an arc-shaped cross section. The surface of the anti-slip portion 202 is smooth and can protect the toes of the hamster from scratches. The same effect can also be achieved by using a groove with an arc-shaped cross section as the anti-slip portion 202. Further, the convex bar is parallel to the axial connection device 100 to achieve a better anti-slip effect.

A central hole 204 and a plurality of through holes 203 for auxiliary locking are opened in the middle of the plastic end cover 205.

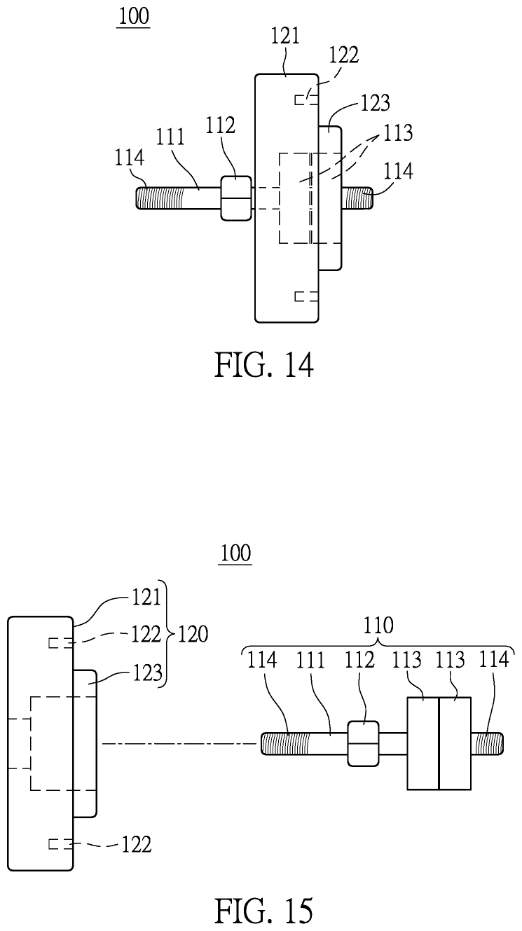

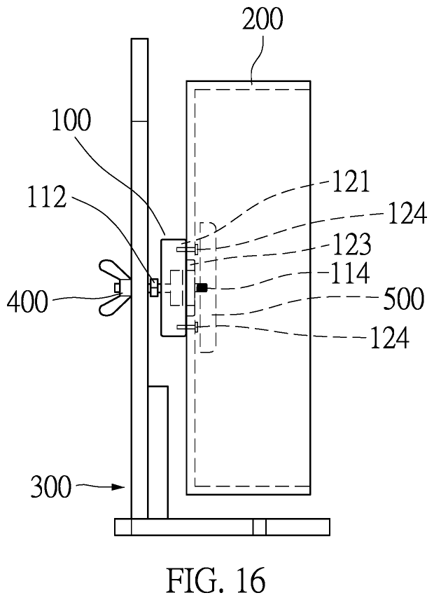

Referring to FIGS. 14 and 15, the axial connection device 100 includes a shaft 111, two bearings 113, and a positioning member 120. The two bearings 113 are fixedly mounted on the shaft 111, furthermore, connecting threads 114 are respectively formed at both ends of the shaft 111, and a clamping position 112 is also formed in the middle of the shaft 111. The above members are combined to form a rotating mechanism 110. The positioning member 120 includes a first positioning portion 123 for cooperating with a center hole 204 of an end cover 205 of the running wheel body 200 to support the running wheel body 200 and embody radial positioning, and a second positioning portion 121 located at one end of the first positioning portion 123 for abutting against the end cover 205 of the running wheel body 200 to embody axial positioning, wherein one end of the second positioning portion 121 adjacent to the running wheel body 200 is further provided with a plurality of locking holes 122 for locking the running wheel body 200. The positioning member 120 is fixedly mounted on the two bearings 113 for carrying the running wheel body 200. More specifically, the two bearings 113 are embedded at a side adjacent to the first positioning portion 123 in the positioning member 120 (the right side in FIG. 14). In this way, the bearings 113 are closer to the center of gravity of the running wheel body 200 (see FIG. 16), which can reduce the wear of the bearings 113 caused by movement and prolong the service life of the running wheel.

The above-mentioned bearings 113 are two bearings, and a gap of 1 mm is between the two bearings 113. In this way, the contact surface between the bearings 113 and the shaft 111 is larger, and there is no friction between the bearings 113. Therefore, the movement is more reliable, and the shaking noise is smaller. The bearings 113 are preferably a rolling bearing. The first positioning portion 123 and the second positioning portion 121 are both circular truncated cone-shaped and axially coincident, which is more convenient to the rotation of the running wheel.

Referring to FIGS. 11-16, the assembly process of the hamster running wheel is as follows. The first positioning portion 123 is inserted into the central hole 204 of the end cover 205 of the running wheel body 200, so that the end cover 205 of the running wheel body 200 is pressed against the second positioning portion 121, then the screw 124 is used to pass through the through hole 203 on the end cover 205 and cooperate with the locking holes 122 on the second positioning portion 121 to lock the running wheel body 200 to the positioning portion 120, the wing nut 400 is used to lock the shaft 111 on the support frame 300, and the protective cover 500 is screwed on the other end of the shaft 111.

The axial connection device 100 is locked to the support frame 300 by the wing nut 400, the clamping position 112 is clamped by pliers, and then the wing nut 400 is twisted to easily lock or loosen the axial connection device 100 to adjust the height of the running wheel body 200.

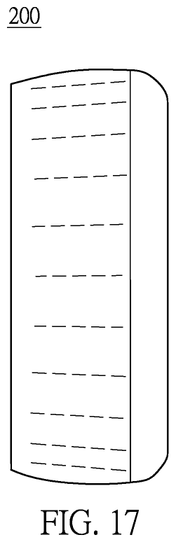

The shape of another embodiment of the running wheel body 200 is shown in FIG. 17. Referring to FIG. 17, in order to make it easier to demold after ultrasonic welding, the wheel circumference portion of the running wheel body 200 is designed as a curved structure which gradually decreases from the back (the right side in FIG. 17) to the mouth (the left side in FIG. 17). The dotted line in FIG. 17 indicates the anti-slip portion.

The present disclosure has been described in detail through specific embodiments above. These detailed descriptions are only limited to helping those skilled in the art understand the content of the present disclosure, and should not be understood as limiting the protection scope of the present disclosure. Various modifications, equivalent transformations, etc., performed by those skilled in the art on the above solutions under the concept of the present disclosure should be included in the protection scope of the present disclosure.

What is claimed is:

1. A hamster running wheel, comprising: a support frame (2) and a running wheel body (1) supported on the support frame (2) through a rotating mechanism (3), wherein the rotating mechanism (3) comprises an axial mechanism (32) and a plurality of bearings (33), wherein the plurality of the bearings (33) are stacked to form a bearing set, and are arranged in series on the axial mechanism (32), wherein inner rings of the plurality of the bearings (33) are fixedly connected to the axial mechanism (32), and outer rings of the plurality of the bearings (33) are fixedly connected to the running wheel body (1).

2. The hamster running wheel according to claim 1, further comprising: an alignment calibration mechanism, wherein the alignment calibration mechanism comprises:
a positioning hole opened in a center of the running wheel body (1); and
a positioning member (4) sleeved on the rotating mechanism (3) and fixedly connected to the outer rings of the plurality of the bearings (33) of the rotating mechanism (3), wherein a first positioning portion (41) is embedded in the positioning hole and cooperates with the positioning hole to radially position the running wheel body (1), and a second positioning portion (42) is located at one end of the first positioning portion (41), and abuts against and cooperates with an end of the running wheel body (1) to axially position the running wheel body (1).

3. The hamster running wheel according to claim 2, wherein the first positioning portion (41) and the second positioning portion (42) both have cylindrical structures and are axially coincident.

4. The hamster running wheel according to claim 2, wherein a plurality of screw holes (43) are provided at an end of the second positioning portion (42) adjacent to the running wheel body (1), and a plurality of installation holes corresponding to the plurality of screw holes (43) are provided on the running wheel body (1), wherein a plurality of screws (9) correspondingly passing through the plurality of installation holes and connecting the plurality of screw holes (43) lock the running wheel body (1) to the positioning member (4).

5. The hamster running wheel according to claim 1, wherein an anti-falling mechanism for running wheel comprises: a fixed end cover (7) and a limiting member (6), wherein the limiting member (6) is fixedly mounted at a near running wheel end (34) of the axial mechanism (32), the fixed end cover (7) is assembled on the near running wheel end (34) of the axial mechanism (32), and the fixed end cover (7) is limited by the limiting member (6) so as to have a gap with the running wheel body (1).

6. The hamster running wheel according to claim 5, wherein a threaded structure is provided on the near running wheel end (34) of the axial mechanism (32), and the fixed end cover (7) is connected to the axial mechanism (32) via the threaded structure, wherein the fixed end cover (7) has a circular structure, the limiting member (6) is a sleeve, and the sleeve is punched and sleeved on the near running wheel end (34) of the axial mechanism (32).

7. The hamster running wheel according to claim 1, further comprising: an auxiliary assembly mechanism, wherein the auxiliary assembly mechanism comprises: a clamping position (5) arranged on the axial mechanism (32) for tool clamping, and a diameter of the clamping position (5) of the axial mechanism (32) is larger than a diameter of a proximal bracket end (31) of the axial mechanism (32).

8. The hamster running wheel according to claim 1, further comprising: a height adjustment mechanism, wherein the height adjustment mechanism comprises: a wing nut (8) and a strip through hole (231) provided on a support portion (23) of the support frame (2), wherein a proximal bracket end (31) of the axial mechanism (32) passes through the strip through hole (231), the wing nut (8) is connected with the proximal bracket end (31) of the axial mechanism (32) to lock the axial mechanism (32) on the support portion (23).

9. An axial connection device for a hamster running wheel for rotatably supporting a running wheel body (200) on a support frame (300), wherein the axial connection device (100) for a hamster running wheel comprises:
a shaft (111);
a bearing (113) mounted on the shaft (111); and
a positioning member (120) mounted on the bearing (113) for carrying the running wheel body (200);
wherein the positioning member (120) comprises: a first positioning portion (123) configured to cooperate with a center hole of a back plate of the running wheel body (200) to support the running wheel body (200) and embody radial positioning, and a second positioning portion (121) located at one end of the first positioning portion (123) and configured to abut against the back plate of the running wheel body (200) to embody axial positioning, wherein the bearing (113) is embedded at a side of the positioning member (120) adjacent to the first positioning portion (123).

10. The axial connection device for a hamster running wheel according to claim 9, wherein the first positioning portion (123) and the second positioning portion (121) are both circular truncated cone-shaped and axially coincident.

11. The axial connection device for a hamster running wheel according to claim 9, wherein one end of the second positioning portion (121) adjacent to the running wheel body (200) is further provided with a plurality of locking holes (122) for locking the running wheel body (200).

12. The axial connection device for a hamster running wheel according to claim 9, wherein a plurality of bearings (113) are mounted on the shaft (111), and the plurality of bearings (113) are arranged side by side.

13. The axial connection device for a hamster running wheel according to claim 12, wherein a gap of 0.5-1.5 mm is between the adjacent bearings (113).

14. The axial connection device for a hamster running wheel according to claim 9, wherein the shaft (111) is further provided with a clamping position (112) that is exposed between the support frame (300) and the back plate of the running wheel body (200) for tool clamping.

15. A safe hamster running wheel convenient to be cleaned, comprising:
a support frame (300); and
a rotatable running wheel body (200) mounted on the support frame (300) via an axial connection device (100), wherein the running wheel body (200) comprises a annular plastic track (201), and a plastic end cover (205) ultrasonically welded at an opening of the annular plastic track (201), wherein an anti-slip portion (202) is provided on a surface of the annular plastic track (201).

16. The safe hamster running wheel convenient to be cleaned according to claim 15, wherein the anti-slip portion (202) is convex bars or grooves with arc-shaped cross sections.

17. The safe hamster running wheel convenient to be cleaned according to claim 16 wherein the convex bars or the grooves are parallel to the axial connection device (100).

18. The safe hamster running wheel convenient to be cleaned according to claim 15, wherein the axial connection device (100) comprises:
a shaft (111);
a bearing (113) mounted on the shaft (111); and
a positioning member (120) mounted on the bearing (113) for carrying the running wheel body (200);
wherein the positioning member (120) comprises: a first positioning portion (123) for cooperating with a center hole (204) of an end cover of the running wheel body (200) to support the running wheel body (200) and embody radial positioning, and a second positioning portion (121) located at one end of the first positioning portion (123) for abutting against the end cover of the running wheel body (200) to embody axial positioning, wherein the bearing (113) is embedded at a side adjacent to the first positioning portion (123) in the positioning member (120).

19. The safe hamster running wheel convenient to be cleaned according to claim 18, wherein a plurality of bearings (113) are provided on the shaft (111), the plurality of bearings (113) are arranged side by side, and a gap of 0.5-1.5 mm is between the adjacent bearings (113).

20. The safe hamster running wheel convenient to be cleaned according to claim 15, wherein the axial connection device (100) is locked to the support frame (300) through a nut (400), and the height is adjustable.
